(19) United States
(12) Patent Application Publication
(10) Pub. No.: US 2022/0230042 A1
(43) Pub. Date: Jul. 21, 2022

(54) COMBINATION OF RADIO FREQUENCY IDENTIFICATION TECHNOLOGY WITH OPTICAL AND/OR QUASI-OPTICAL IDENTIFICATION TECHNOLOGIES

(71) Applicant: Avery Dennison Retail Information Services LLC, Mentor, OH (US)

(72) Inventor: Ian FORSTER, Chelmsford (GB)

(21) Appl. No.: 17/612,478

(22) PCT Filed: May 29, 2020
(86) PCT No.: PCT/US2020/035181

§ 371 Date: Nov. 18, 2021

Related U.S. Application Data
(60) Provisional application No. 62/854,148, filed on May 29, 2019.

(51) Int. Cl. G06K 19/077; G06K 19/08; G06K 19/06

(52) U.S. Cl. CPC G06K 19/07775; G06K 19/0614; G06K 19/07786; G06K 19/08

(57) ABSTRACT

RFID devices are provided with an antenna coupled to an RFID chip by a direct or indirect connection. A data-carrying pattern that is visible at one or more wavelengths is incorporated into and/or onto the antenna. The pattern may comprise a plurality of apertures defined in the antenna or a material applied onto the antenna and having a property or properties different from a property or properties of the material used to form the antenna at one or more wavelengths. The pattern may carry data that is optically readable at one wavelength and quasi-optically readable at another wavelength. The pattern may include at least one sensing material configured to cause the pattern to present different data depending on whether a condition is existent or not. The antenna may include a plurality of layers, each with patterns or portions of a pattern or patterns that are visible at different wavelengths.

### CROSS REFERENCE TO RELATED APPLICATION

The present application claims priority to and the benefit of United States provisional utility patent application No. 62/854,148 filed May 29, 2019, which is incorporated herein by reference in its entirety.

### FIELD

The present subject matter relates to radio frequency identification (“RFID”) devices. More particularly, the present subject matter relates to the incorporation of optical and/or quasi-optical identification features into RFID devices.

### BACKGROUND

RFID tags are widely used to associate an object with an identification code. RFID devices generally have a combination of antennas and analog and/or digital electronics, which may include, for example, communications electronics, data memory, and control logic. For example, RFID tags are used in conjunction with security locks in cars, for access control to buildings, and for tracking inventory and parcels. Some examples of RFID tags and labels appear in U.S. Pat. Nos. 6,107,920; 6,206,292; and 6,262,692, all of which are hereby incorporated herein by reference in their entireties.

A typical RFID tag includes an RFID chip (which may include an integrated circuit) electrically coupled to an antenna, which is capable of sending signals to and/or receiving signals from an RFID reader within range of the RFID device. The antenna is commonly formed of a conductive material (e.g., copper, aluminum, or nickel or organic conducting material, such as graphene-based materials) and configured as a thin, flat element, which may be provided as a foil material or formed by being printed onto a substrate (e.g., a paper or fabric or plastic material) of the RFID device.

Optical and quasi-optical technologies allow for different forms of data transmission and may be used in combination with RFID technology, though it is conventional for RFID devices to be formed separately from structures having optical and/or quasi-optical patterns.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as may be set forth in the claims appended hereto.

RFID devices, such as tags or labels, in which the antenna has incorporated therein or thereon one or more data-carrying patterns that are visible or readable using optical or quasi-optical technologies are described herein. In some embodiments, the RFID device includes an antenna and an RFID chip coupled to the antenna. In some embodiments, the antenna is directly connected to the RFID chip. In other embodiments, the antenna is not directly connected to the RFID chip. In some embodiments, the RFID device is as described above and the RFID chip defines a portion of the pattern. In other embodiments, the data-carrying pattern contains a plurality of apertures defined in the antenna. In some embodiments, the structural changes of the antenna do not substantially change the RF operation of the antenna in a set of tests related to the intended use of the RFID tag.

In some embodiments, a data-carrying pattern that is visible at one or more wavelengths is incorporated into and/or onto the antenna. In some embodiments, the RFID device is as described above and the pattern carries or contains data that are optically readable at a first wavelength and data that are optically readable at a second wavelength.

In other embodiments, the RFID device includes an antenna and an RFID chip coupled to the antenna. A data-carrying pattern that is visible at one or more wavelengths is incorporated into and/or onto the antenna, and the pattern contains a material applied onto the antenna that has one or more properties different from one or more properties of the material used to form the antenna at the one or more wavelengths at which the pattern is readable.

In other embodiments, the pattern carries or contains at least one sensing material configured to cause the pattern to present data having a first state when a condition is existent and to present data having a second state when the condition is not existent.

In still other embodiments, the antenna can be composed of a series of functional elements, representing binary bits. The amount of wire in a bit is independent of the binary bit status, 0 or 1. The encoding is sequential across the tag from one end to other, or symmetric across a central area carrying the RFID chip. As the length of wire in each dipole section is constant, the RF performance, over a given set of tests, for example on a set of fabrics representing the intended end use.

In still other embodiments, data can be encoded into symbols along the length of the dipole, where the length of elements encode binary digits. The difference in one direction (e.g., Y direction) is made as short as possible to minimize the total length change of the arm of the antenna. To mitigate the effects on the antenna, the portion of the antenna forming the other half or the dipole can be encoded with the opposite binary data, so the total length of the two dipole elements is always a constant. Alternatively, an alternate method of encoding data involves encoding 2 bits in a symbol by altering the length of one element in the total length x in 4 steps. It will be appreciated by using further increments of x in a given symbol, more bits can be encoded, making the total code available greater. For example, with 16 states, 4 bits can be encoded per symbol; assuming both halves of the antenna are encoded with data, 6 symbols, 3 meander sections of antenna, will encode 96 bits of information, a common length of data used for RFID tags.

In other embodiments, the encoding methodology involves the combination of an RFID chip unique ID and structural coding. For example, the scheme can involve a cryptographic method that relies on a secret and public key, where the chip is pre-programmed at a wafer fabrication facility with a not writeable unique ID and manufacturer data encoded into the read write memory. In this way, the authenticity of a product may be determined by reading the structurally encoded data, chip unique ID and EPC memory and decoding with a public key.

In still other embodiments, two structurally encoded tags which, when a test of predicted range against frequency is carried out, give similar response inside a required range. Which structurally encoded schemes do give the required similarity in RF response can be determined by test or by electromagnetic simulation, in the event that not all data structures work, and the invalid codes highlighted so as to not be used in certain applications.

The data or code can be read using a variety of techniques known in the art. Exemplary methods include using a metal detector to scan along the antenna and detect the wires at intervals, retrieving the code; electromagnetic energy, for example optical, infra-red or X-Ray, to detect the wires by either reflection or transmission, depending on the materials the wires are embedded in; and ultrasonic probe to detect the contrast between the relatively hard wire and soft fabric or other materials.

In still other embodiments, structural encoding can be done by changing the shape or morphology of the wire. For example, a round wire can be modified at points along its length by crushing using a tool, making the metal ‘pancake’ out, changing the apparent width of the wire at intervals. Alternatively, the wire can be squeezed in a tool, locally reducing the wire diameter. The wire width at a particular point can be determined using methods similar to those described above to recover the data.

In some embodiments, the data that is stored or patterned into the structure of an RFID (e.g., antenna) can be complementary to the data stored in the RFID tag, such as data elements that form parts of an anti-counterfeiting schemes or as a backup scheme for part or all of the data in the event the RFID tag ceases to function (e.g. due to accidental or intentional damage).

In some embodiments, the functionality of the RFID tag (or antenna) can be changed. For example, the change in functionality of the RFID tag (or antenna) can be deliberate, such as part of an action to protect consumer privacy or prevent triggering of an RFID-based EAS system, or after the tag stops functioning after an extended period on an item, such as a garment, to assist with recycling or other operations.

Methods of manufacturing the RFID devices described herein are also disclosed. In some embodiments, the method includes providing a conductor (e.g., antenna) and defining a data-carrying pattern that is visible at one or more wavelengths into and/or onto the conductor. In some embodiments, the conductor is coupled to an RFID chip as an antenna, and the pattern is defined into and/or onto the conductor by one or more of punching, selective etching, die cutting or laser cutting.

In some embodiments, the RFID devices are manufactured as described above and the pattern is defined by selectively printing the conductor, with conductive ink, to define a plurality of apertures. In other embodiments, the pattern is defined by additively printing a material having a property or properties different from a property or properties of the conductive ink at said one or more wavelengths onto the conductive ink.

### BRIEF DESCRIPTION OF THE DRAWINGS

FIG. 1 is a top plan view of an RFID device according to aspects of the present disclosure, with a patterned antenna directly connected to an RFID chip;

FIG. 2 is a top plan view of a portion of the antenna of the RFID device of FIG. 1, with an associated face material or second layer;

FIG. 3 is a top plan view of a surface insensitive RFID device according to aspects of the present disclosure;

FIG. 4 is a side elevational view of the RFID device of FIG. 3;

FIG. 5 is a top plan view of another embodiment of an RFID device according to aspects of the present disclosure, with an RFID chip defining a portion of a pattern incorporated into an antenna; and

FIG. 6 is a top plan view of an RFID device according to aspects of the present disclosure, with a patterned antenna not directly connected to an RFID chip.

FIG. 7 shows a prior art tag where an antenna is made from a wire sewn or woven into a fabric structure, such as part of a garment or an additional element such as a fabric label. The structure of the tag is constant regardless of the product in a defined range it is attached to.

FIG. 8 illustrates a tag design where the dipole section is constructed according to the disclosure.

FIG. 9 shows another method of encoding data into symbols along the length of the dipole, where the length of the elements encode binary digits.

FIG. 10 shows an alternate method of encoding where 2 bits are encoded in a symbol, by altering the length of one element in the total length x in 4 steps.

FIG. 11 illustrates a scheme were structurally encoded is combined via a cryptographic method, for example a secret and public key, with the pre-programmed at a wafer fabrication facility and not writeable unique ID and manufactures data, to be encoded into the read write memory.

FIG. 12 illustrates two structurally encoded tags which, when a test of predicted range against frequency is carried out, give similar response inside a required range.

FIG. 13 illustrates how a structurally encoded tag can be used in returns management.

FIG. 14 shows how the structurally encoded tag information can be used to assist in recycling a garment or other product at the end of life, where the RFID tag is highly likely to have failed due to washing and flexing.

FIG. 15 shows some methods of reading a code; in FIG. 15(a) a metal detector is scanned along the antenna and detects the wires at intervals, retrieving the code. In FIG. 15(b) electromagnetic energy, for example optical, infra-red or X-Ray, is used to detect the wires by either reflection or transmission, depending on the materials the wires are embedded in.

FIG. 16 shows an alternate embodiment of the structural encoding where a round wire is modified at points along its length by crushing using a tool, making the metal ‘pancake’ out, changing the apparent width of the wire at intervals.

### DETAIL DESCRIPTION

As required, detailed embodiments of the present disclosure are set out herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner.

### I. Encoding Data In To the Structure of RFID Tags

A. RFID

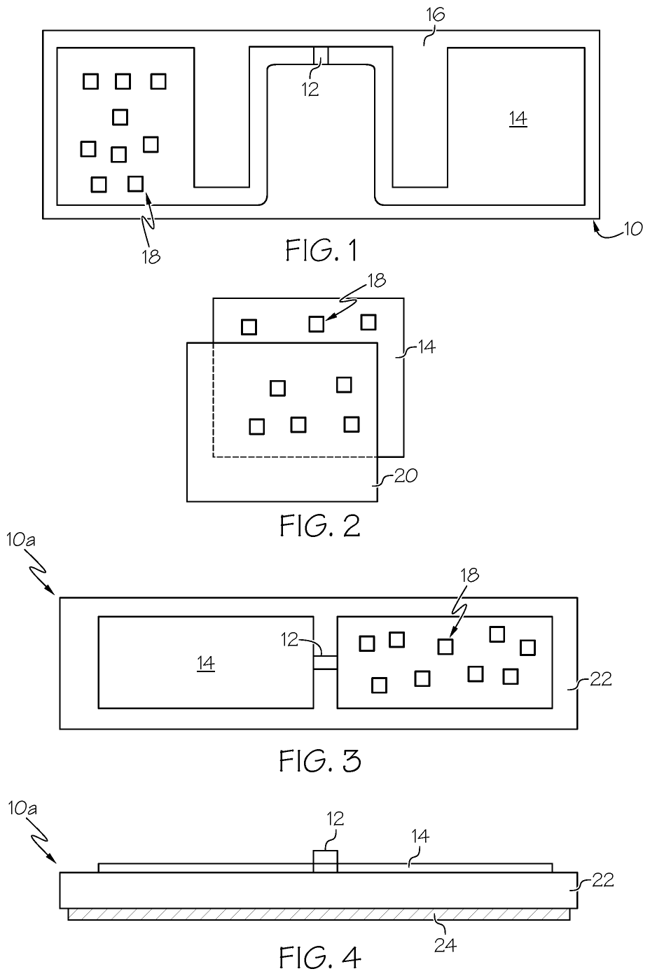

FIG. 1 shows an RFID device 10 according to an aspect of the present disclosure, with the RFID device 10 including an RFID chip 12 coupled to an antenna 14 that is secured to a substrate or base 16 (which may be formed of a paper or fabric or plastic material, for example). In the embodiment of FIG. 1 (as in embodiments shown in FIGS. 3-5), the antenna 14 is directly connected to the RFID chip 12, though it is also within the scope of the present disclosure for an antenna to not be directly connected to an RFID chip (as in the embodiment of FIG. 6).

The RFID chip 12 may take any of a number of forms, including any of a number of possible components and being configured to perform any of a number of possible functions.

RFID chips can be categorized as low frequency (LF), high frequency (HF), and ultra-high frequency (UHF).

A typical RFID device generally includes an antenna for wirelessly transmitting and/or receiving RF signals and analog and/or digital electronics operatively connected thereto. So called active or semi-passive RFID devices may also include a battery or other suitable power source. Commonly, the electronics are implemented via an integrated circuit (IC) or microchip or other suitable electronic circuit and may include, e.g., communications electronics, data memory, control logic, etc. In operation, the IC or microchip functions to store and/or process information, modulate and/or demodulate RF signals, as well as optionally performing other specialized functions. In general, RFID devices can typical retain and communicate enough information to uniquely identify individuals, packages, inventory and/or other like objects, e.g., to which the RFID device is affixed.

Commonly, an RFID reader or base station is used to wirelessly obtain data or information (e.g., such as an identification code) communicated from an RFID device. Typically, an RFID device is configured to store, emit, or otherwise exhibit an identification code or other identifier(s). The manner in which the RFID reader interacts and/or communicates with the RFID device generally depends on the type of RFID device. A given RFID device is typically categorized as a passive device, an active device, a semi-passive device (also known as a battery-assisted or semi-active device) or a beacon type RFID device (which is generally considered as a sub-category of active devices). Passive RFID devices generally use no internal power source, and as such, they are passive devices which are only active when an RFID reader is nearby to power the RFID device, e.g., via wireless illumination of the RFID device with an RF signal and/or electromagnetic energy from the RFID reader. Conversely, semi-passive and active RFID devices are provided with their own power source (e.g., such as a small battery). To communicate, conventional RFID devices (other than so called beacon types) respond to queries or interrogations received from RFID readers. The response is typically achieved by backscattering, load modulation and/or other like techniques that are used to manipulate the RFID reader's field. Commonly, backscatter is used in far-field applications (i.e., where the distance between the RFID device and reader is greater than approximately a few wavelengths), and alternately, load modulation is used in near-field applications (i.e., where the distance between the RFID device and reader is within approximately a few wavelengths).

Passive RFID devices typically signal or communicate their respective data or information by backscattering a carrier wave from an RFID reader. That is, in the case of conventional passive RFID devices, in order to retrieve information therefrom, the RFID reader typically sends an excitation signal to the RFID device. The excitation signal energizes the RFID device which transmits the information stored therein back to the RFID reader. In turn, the RFID reader receives and decodes the information from the RFID device.

As previously noted, passive RFID devices commonly have no internal power supply. Rather, power for operation of a passive RFID device is provided by the energy in the incoming RF signal received by the RFID device from the RFID reader. Generally, a small electrical current induced in the antenna of the RFID device by the incoming RF signal provides sufficient power for the IC or microchip in the RFID device to power up and transmit a response. This means that the antenna generally has to be designed both to collect power from the incoming signal and also to transmit the outbound backscatter signal.

Passive RFID devices have the advantage of simplicity and long life (e.g., having no battery to go dead). Nevertheless, their performance may be limited. For example, passive RFID devices generally have a more limited range as compared to active RFID devices.

Active RFID devices, as opposed to passive ones, are generally provisioned with their own transmitter and a power source (e.g., a battery, photovoltaic cell, etc.). In essence, an active RFID device employs the self-powered transmitter to broadcast a signal which communicates the information stored on the IC or microchip in the RFID device. Commonly, an active RFID device will also use the power source to power the IC or microchip employed therein.

Generally, there are two kinds of active RFID devices-one can be considered as a transponder type of active RFID device and the other as a beacon type of active RFID device. A significant difference is that active transponder type RFID devices are only woken up when they receive a signal from an RFID reader. The transponder type RFID device, in response to the inquiry signal from the RFID reader, then broadcasts its information to the reader. As can be appreciated, this type of active RFID device conserves battery life by having the device broadcast its signal only when it is within range of a reader. Conversely, beacon type RFID devices transmit their identification code and/or other data or information autonomously (e.g., at defined intervals or periodically or otherwise) and do not respond to a specific interrogation from a reader.

Generally, active RFID devices, due to their on-board power supply, may transmit at higher power levels (e.g., as compared to passive devices), allowing them to be more robust in various operating environments. However, the battery or other on-board power supply can tend to cause active RFID devices to be relatively larger and/or more expensive to manufacture (e.g., as compared to passive devices). Additionally, as compared to passive RFID devices, active RFID devices have a potentially more limited shelf life—i.e., due to the limited lifespan of the battery. Nevertheless, the self-supported power supply commonly permits active RFID devices to include generally larger memories as compared to passive devices, and in some instances the on-board power source also allows the active device to include additional functionality, e.g., such as obtaining and/or storing environmental data from a suitable sensor.

Semi-passive RFID devices are similar to active devices in that they are typically provisioned with their own power source, but the battery commonly only powers the IC or microchip and does not provide power for signal broadcasting. Rather, like passive RFID devices, the response from the semi-passive RFID device is usually powered by means of backscattering the RF energy received from the RFID reader, i.e., the energy is reflected back to the reader as with passive devices. In a semi-passive RFID device, the battery also commonly serves as a power source for data storage.

A conventional RFID device will often operate in one of a variety of frequency ranges including, e.g., a low frequency (LF) range (i.e., from approximately 30 kHz to approximately 300 kHz), a high frequency (HF) range (i.e., from approximately 3 MHz to approximately 30 MHz) and an ultra-high frequency (UHF) range (i.e., from approximately 300 MHz to approximately 3 GHz). A passive device will commonly operate in any one of the aforementioned frequency ranges. In particular, for passive devices: LF systems commonly operate at around 124 kHz, 125 kHz or 135 kHz; HF systems commonly operate at around 13.56 MHz; and, UHF systems commonly use a band anywhere from 860 MHz to 960 MHz. Alternately, some passive device systems also use 2.45 GHz and other areas of the radio spectrum. Active RFID devices typically operate at around 455 MHz, 2.45 GHz, or 5.8 GHz. Often, semi-passive devices use a frequency around 2.4 GHz.

The read range of an RFID device (i.e., the range at which the RFID reader can communicate with the RFID device) is generally determined by many factors, e.g., the type of device (i.e., active, passive, etc.). In some embodiments, passive LF RFID devices (also referred to as LFID or LowFID devices) can usually be read from within approximately 12 inches (0.33 meters); passive HF RFID devices (also referred to as HFID or HighFID devices) can usually be read from up to approximately 3 feet (1 meter); and passive UHF RFID devices (also referred to as UHFID devices) can be typically read from approximately 10 feet (3.05 meters) or more. However, the distances above are exemplary and the distances may vary (e.g., longer or shorter) depending on the characteristics listed above. One important factor influencing the read range for passive RFID devices is the method used to transmit data from the device to the reader, i.e., the coupling mode between the device and the reader-which can typically be either inductive coupling or radiative/propagation coupling. Passive LFID devices and passive HFID devices commonly use inductive coupling between the device and the reader, whereas passive UHFID devices commonly use radiative or propagation coupling between the device and the reader.

In inductive coupling applications (e.g., as are conventionally used by passive LFID and HFID devices), the device and reader are typically each provisioned with a coil antenna that together form an electromagnetic field there between. In inductive coupling applications, the device draws power from the field, uses the power to run the circuitry on the device's IC or microchip and then changes the electric load on the device antenna. Consequently, the reader antenna senses the change or changes in the electromagnetic field and converts these changes into data that is understood by the reader or adjunct computer. Because the coil in the device antenna and the coil in the reader antenna have to form an electromagnetic field there between in order to complete the inductive coupling between the device and the reader, the device often has to be fairly close to the reader antenna, which therefore tends to limit the read range of these systems.

Alternately, in radiative or propagation coupling applications (e.g., as are conventionally used by passive UHFID devices), rather than forming an electromagnetic field between the respective antennas of the reader and device, the reader emits electromagnetic energy which illuminates the device. In turn, the device gathers the energy from the reader via its antenna, and the device's IC or microchip uses the gathered energy to change the load on the device antenna and reflect back an altered signal, i.e., backscatter. Commonly, UHFID devices can communicate data in a variety of different ways, e.g., they can increase the amplitude of the reflected wave sent back to the reader (i.e., amplitude shift keying), shift the reflected wave so it is out of phase received wave (i.e., phase shift keying) or change the frequency of the reflected wave (i.e., frequency shift keying). In any event, the reader picks up the backscattered signal and converts the altered wave into data that is understood by the reader or adjunct computer.

The antenna employed in an RFID device is also commonly affected by numerous factor, e.g., the intended application, the type of device (i.e., active, passive, semi-active, etc.), the desired read range, the device-to-reader coupling mode, the frequency of operation of the device, etc. For example, insomuch as passive LFID devices are normally inductively coupled with the reader, and because the voltage induced in the device antenna is proportional to the operating frequency of the device, passive LFID devices are typically provisioned with a coil antenna having many turns in order to produce enough voltage to operate the device's IC or microchip. Comparatively, a conventional HFID passive device will often be provisioned with an antenna which is a planar spiral (e.g., with 5 to 7 turns over a credit-card-sized form factor), which can usually provide read ranges on the order of tens of centimeters. Commonly, HFID antenna coils can be less costly to produce (e.g., compared to LFID antenna coils), since they can be made using techniques relatively less expensive than wire winding, e.g., lithography or the like. UHFID passive devices are usually radiatively and/or propagationally coupled with the reader antenna and consequently can often employ conventional dipole-like antennas.

B. Patterned Antenna

For example, in one embodiment, the RFID chip 12 includes an integrated circuit for controlling communication and other functions of the RFID device 10.

As for the antenna 14, it may be variously configured without departing from the scope of the present disclosure. For example, in one embodiment, the antenna 14 may be formed of a foil material, a conductive ink, an organic conducting material, such as graphene-based materials, or combinations thereof. Regardless of the material composition, method of manufacture, and/or configuration, the antenna 14 is formed of a conductive material having an associated pattern 18. The pattern 18 may be variously configured without departing from the scope of the present disclosure, provided that it is visible at one or more wavelengths. In the illustrated embodiment, the pattern 18 is configured as a two-dimensional or matrix bar code or image, but other configurations may also be employed.

The pattern 18 may be formed into and/or onto the antenna 14. For example, if the antenna 14 is formed of a foil material, the foil material could be punched, selectively etched, die cut, or laser cut in order to define a plurality of apertures comprising portions of the pattern 18. If the antenna 14 is formed of a conductive ink, all or a portion of the pattern 18 could be defined by selectively printing the ink so as to form a plurality of apertures comprising portions of the pattern 18. The apertures expose the substrate or base 16 underlying the antenna 14, which is formed of a material having one or more properties different from one or more properties of the antenna material at one or more wavelengths (i.e., with the substrate or base material being differently visible at one wavelength than the antenna material). All or a portion of the pattern 18 could instead be formed by applying a material onto the antenna 14, with the material having a property or properties different from a property or properties of the conductor used to form the antenna 14 at one or more wavelengths (i.e., with the pattern material being differently visible at one wavelength than the antenna material). For example, an ultraviolet-fluorescent ink could be additively printed onto an antenna 14 formed of a foil material or a conductive ink.

The pattern 18 carries data, allowing a suitable scanner system to resolve an image of the pattern 18 and then decode the data. The nature of the scanner system may vary depending on the nature of the pattern 18 and the wavelength at which the pattern 18 is visible. For example, in one embodiment, an antenna 14 is loaded with a dense material, such as various barium salts, which renders the pattern 18 visible at very short penetrating wavelengths, such as X-rays. In that case, the scanner system could be a conventional X-ray system, such as the type configured to analyze a living body. While operation of a conventional RFID device could be interfered with by the presence of an X-ray field and/or the presence of body tissues and liquids, an RFID device 10 with a pattern 18 configured to be read by an X-ray system could be placed within a person. Such an RFID device 10 would be capable of being used inside and outside of the person, with an RF field being used for inventory and/or authentication purposes (e.g., to track a “use-by” date and/or sterilization history) prior to placement inside the person and an X-ray field being used to retrieve data from the pattern 18 when the RFID device 10 is positioned within the person.

It should be understood that an individual pattern 18 is not limited to detection at a single wavelength or within a single range of wavelengths, but that an individual pattern 18 may be detectable at multiple wavelengths, which may include wavelengths having different properties. For example, a single pattern 18 may include data that is optically readable at a first wavelength and the same or different data that is quasi-optically readable at a second (millimeter) wavelength. The different wavelengths at which the pattern 18 is readable may be selected due to the conditions in which it is anticipated that the RFID device 10 will be used and/or advantages in specific reading situations, for example.

Detectability at different wavelengths may be achieved according to any of a number of suitable approaches. In one embodiment, different portions of the pattern 18 may be configured to be readable at different wavelengths, such as with a first portion that is defined by apertures exposing the substrate or base 16 beneath the antenna 14 and a second portion defined by an applied material that is readable at a wavelength different from that of the first portion. In another embodiment, the antenna 14 may include a plurality of layers, such as in FIG. 2, which shows a second layer 20. In such an embodiment, the pattern 18 or a portion of the pattern 18 defined directly into or onto the antenna 14 may be visible at a first wavelength, while the pattern or portion of the pattern defined in and/or on the second layer 20 is visible at a second wavelength. This may include a pattern or portion of a pattern of the second layer 20 that directly overlays a pattern or portion of a pattern of the antenna 14, provided that the pattern or portion of a pattern of the second layer 20 is not opaque at a wavelength at which the pattern or portion of a pattern of the antenna 14 is visible. The second layer 20 may at least partially contain a face material that is opaque at some other wavelength, such as when the second layer 20 comprises a white polyethylene terephthalate material (which is opaque to red light having a wavelength of 635 nm) carrying a printed bar code or human-readable data that does not interfere with reading of the pattern 18 of the antenna 14 (e.g., by the face material transmitting a millimeter wave). It should be understood that, while FIG. 2 shows an embodiment of an antenna 14 having two layers (counting the antenna 14 itself as a layer), more layers (e.g., 3, 4, 5, 6, or more) may be applied to the antenna 14 to impart visibility at additional wavelengths.

Indeed, if a patterned antenna includes a plurality of layers (effectively creating a three-dimensional pattern), care should be taken to assure that the pattern of one layer does not interfere with visibility of a layer that is covers. For example, a pattern configured to be read optically could be overlaid by a film that is transparent to wavelengths in the range of 600 to 800 nm, with a code applied in ultraviolet-fluorescent ink to the film. In general, a pattern configured to be read at a longer wavelength may be placed beneath a pattern configured to be read at a shorter wavelength (e.g., with a pattern configured to be read at an ultraviolet wavelength being placed above a pattern configured to be read at a visible wavelength, which is placed above a pattern configured to be read at an infrared or millimeter wavelength). In one embodiment, the pattern or patterns of an antenna must be read at all of the applicable wavelengths to recover all of the two (or more)-dimensionally coded data, with the patterns being read simultaneously or at different times.

C. Frequencies

According to another aspect of the present disclosure (which may be practiced alone or in combination with one or more other aspects described herein), the RFID chip 12 provides a modulated reflection at both ultra-high and millimeter wave or extremely high frequencies (“UHF” and “EHF,” respectively). This may be achieved, for example, by configuring the antenna 14 so as to have two separate resonances at the two frequencies. The RFID device 10 is powered by rectification of the signal at one frequency, which may be UHF, as detectors for converting radio frequency to direct current are efficient and may be manufactured using common, low-cost semiconductor technologies. The modulation transistor used, however, to send a signal back at UHF is simpler than an efficient power rectifier/detector and a degree of modulation at both UHF and EHF is possible from a transistor manufactured according to the same low-cost semiconductor technology. The modulated reflection can be picked up by the same system that is scanning the pattern 18 at the second (e.g., millimeter wave) frequency so, when the RFID device 10 is being interrogated by another system at UHF, the data response can be combined with the data read from the pattern 18.

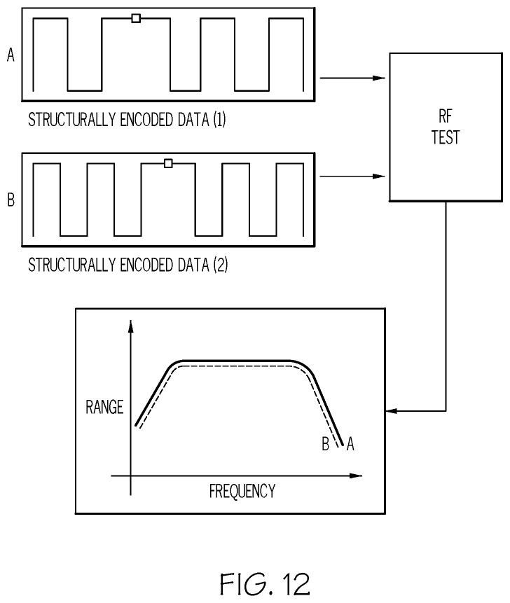

FIG. 12 illustrates two structurally encoded tags which, when a test of predicted range against frequency is carried out, give similar response inside a required range. Which structurally encoded schemes do give the required similarity in RF response can be determined by test or by electromagnetic simulation, in the event that not all data structures work, and these invalid codes highlighted not to be used in certain applications.

D. Sensing Materials

According to yet another aspect of the present disclosure (which may be practiced alone or in combination with one or more other aspects described herein), one or more of the regions or elements of the pattern 18 is associated with a sensing material. The sensing material causes the pattern 18 or a portion thereof to present data having a first state when a condition is existent and to present data having a second state when the condition is not existent. In one embodiment, the data may be read as a digital “1” when the condition is existent and be read as a digital “0” when the condition is not existent (or vice versa). Such a configuration may be advantageous in signalling whether a particular substance is present or not in the vicinity of the RFID device 10. Typical substances to be sensed may include liquids (e.g., water), organic materials (e.g., alcohols and sugars in solution), metabolites (e.g., illegal and prescription drugs), gases (e.g., carbon monoxide), and complex hydrocarbons (e.g., benzene and its derivatives). It should be understood that the data presented in the different states is not limited to binary digital values, but that intermediate values can be presented, which may be representative of a variation in reflectivity. According to one implementation of such an approach, the comparison is differential, meaning that the reflectivity of a pattern element or region that is not affected by the condition to be sensed is compared in reflectivity to one that is affected by the condition. Providing a differential value may be advantageous compared to providing an absolute value, as such an approach may be less susceptible to effects such as adsorption. An intermediate value may be indicative of not only the existence or non-existence of a condition, but a degree associated with the condition (e.g., the concentration of a substance in a solution).

FIGS. 3 and 4 illustrate another possible configuration of an RFID device 10a according to a further aspect of the present disclosure. It should be understood that the preceding concepts may be incorporated into the RFID device 10a of FIGS. 3 and 4.

In the embodiment of FIGS. 3 and 4, an RFID device 10a is further provided with a dielectric material or separator 22 and a conductive backplane or ground plane 24, with the patterned antenna 14 and RFID chip 12 associated to one surface of the dielectric material 22 and the conductive backplane 24 (which may be formed of a metallic material, for example) being associated with an opposing surface of the dielectric material 22. Such an RFID device 10a may be referred to as being “surface insensitive,” as its configuration allows it to be read when it is placed on a substance (e.g., a metal or liquid) that would normally prevent it from operating efficiently. In particular, the pattern 18 incorporated into the antenna 14 may be detected at a range of wavelengths, as previously described. The dielectric material 22 (which serves as a substrate or base and, in one embodiment, is formed by a 0.5 mm-thick layer of foam) is configured to act as a reflector with, for example, a quarter wave or half wave at a wavelength such as that of millimeter waves. By such a configuration, apertures defining all or a portion of the pattern 18 (which expose the portion of the dielectric material 22 underlying the antenna 14) will have either enhanced reflectivity or reduced reflectivity compared to the antenna material, thereby improving the image resolution and allowing it to be detected at longer range.

E. Authentication

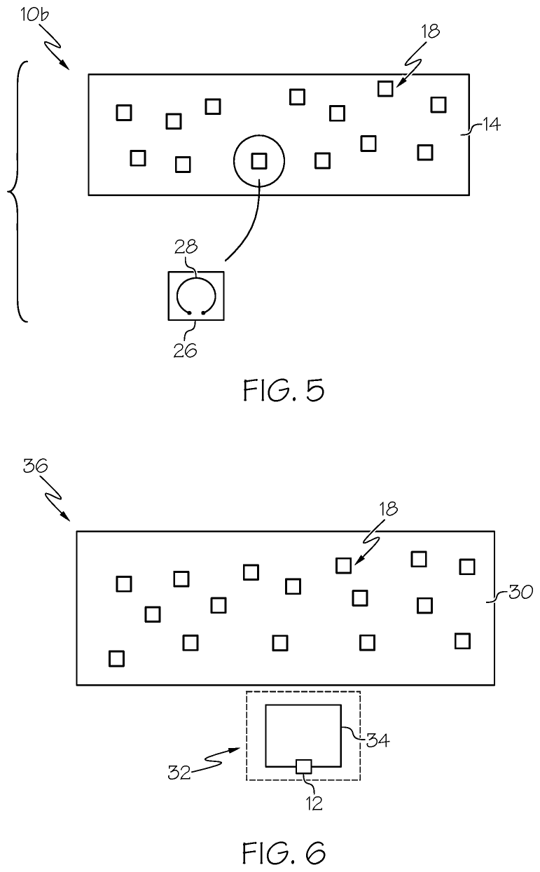

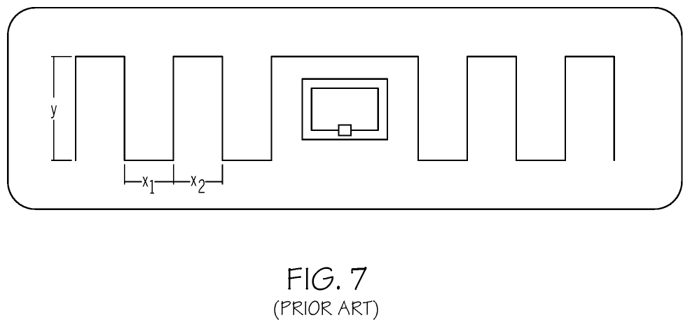

According to another aspect of the present disclosure, which is illustrated in FIG. 5, an RFID device 10b may include an RFID chip 26 that defines a portion of a pattern 18 incorporated into an antenna 14 of the RFID device 10b. Such a configuration allows a scanning system to receive both the data recorded in the RFID chip 26 and the data presented by the pattern 18. In the illustrated embodiment, the RFID chip 26 includes an associated millimeter wave antenna 28, but it should be understood that such an antenna 28 may also be omitted. The data from the RFID chip 26 and the pattern 18 may be related to each other, such as relating to the same product or, using a suitable cryptographic method, with the RFID chip 26 and the pattern 18 being configured so as to effectively create a private key, with authenticity of the relationship being determined by reading both data sources and decoding with a public key.

While the RFID devices shown in FIGS. 1, 3, 4, and 5 employ an antenna directly connected to an RFID chip, it should be understood that the principles described herein may also be employed with a conductor or antenna that is not directly connected to an RFID chip, but is rather wirelessly connected to the RFID chip, as shown in the embodiment of FIG. 6. In the embodiment of FIG. 6, a pattern 18 is incorporated into a conductor 30 (as described above) that is not necessarily configured for RF communication. In the illustrated embodiment, the conductor 30 is configured similarly to the antenna shown in FIG. 5, but it should be understood that the conductor 30 may be differently configured without departing from the scope of the present disclosure. While the conductor 30 is not necessarily configured for RF communication, a structure referred to as a reactive strap 32 (in which an RFID chip 12 with an associated conductive loop or nearfield antenna 34 resonating at a frequency in the UHF range) may be brought into proximity with the conductor 30, which allows the conductor 30 to cooperate with the reactive strap 32 to define an RFID device 36, with the conductor 30 acting an antenna for the RFID device 36.

FIG. 11 illustrates a scheme involving the combination of an RFID chip unique ID and structural encoding. For example, the scheme can involve a cryptographic method that relies on a secret and public key, where the chip is pre-programmed at a wafer fabrication facility with a not writeable unique ID and manufacturer data encoded into the read write memory. In this way, the authenticity of a product may be determined by reading the structurally encoded data, chip unique ID and EPC memory and decoding with a public key.

F. Other Methodologies

1. Dipole

FIG. 8 illustrates a tag design where the dipole section is constructed according to the disclosure. The antenna can be considered to be composed of a series of functional elements, representing binary bits. The amount of wire in a bit is independent of the binary bit status, 0 or 1. The encoding is sequential across the tag from one end to other, or symmetric across a central area carrying the RFID chip. As the length of wire in each dipole section is constant, the RF performance, over a given set of test, for example on a set of fabrics representing the intended end use.

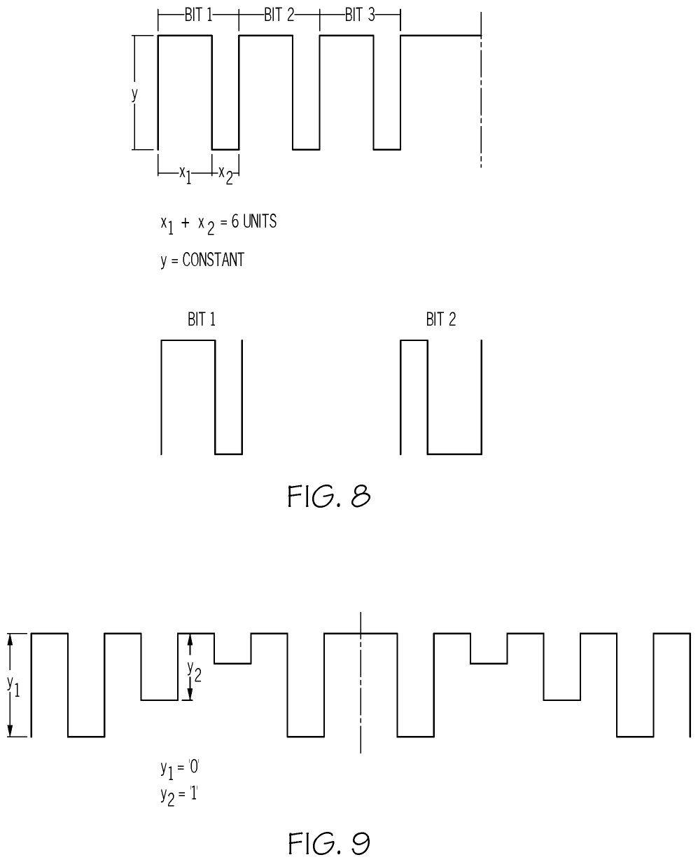

FIG. 9 shows another method of encoding data into symbols along the length of the dipole, where the length of the elements encode binary digits. In this case the difference in Y direction is made as short as possible to minimize the total length change of the arm of the antenna. To mitigate the effects on the antenna, the portion of the antenna forming the other half or the dipole can be encoded with the opposite binary data, so the total length of the two dipole elements is always a constant.

2. Symbols

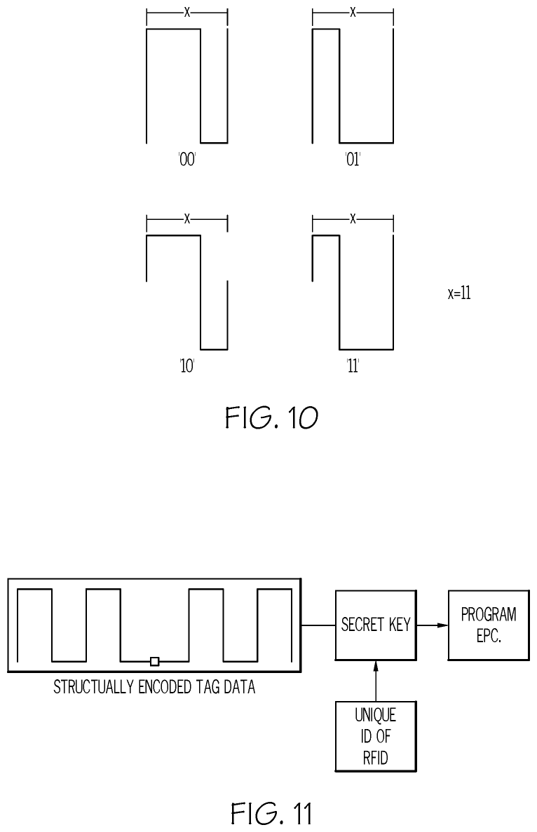

FIG. 10 shows an alternate method of encoding where 2 bits are encoded in a symbol, by altering the length of one element in the total length x in 4 steps. It will be appreciated by using further increments of x in a given symbol, more bits can be encoded, making the total code available greater. For example, with 16 states, 4 bits can be encoded per symbol; assuming both halves of the antenna are encoded with data, 6 symbols, 3 meander sections of antenna, will encode 96 bits of information, a common length of data used for RFID tags.

3. Wire Detection or Modification

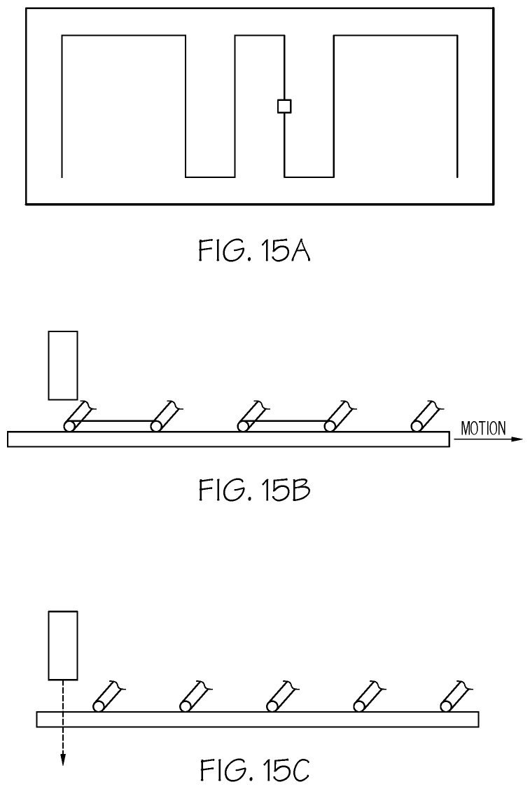

FIG. 15 shows some methods of reading a code; in FIG. 15(a) a metal detector is scanned along the antenna and detects the wires at intervals, retrieving the code. In FIG. 15(b) electromagnetic energy, for example optical, infra-red or X-Ray, is used to detect the wires by either reflection or transmission, depending on the materials the wires are embedded in. An alternative to the metal detector shown in FIG. 15(a) is to use an ultrasonic probe to detect the contrast between the relatively hard wire and soft fabric or other materials.

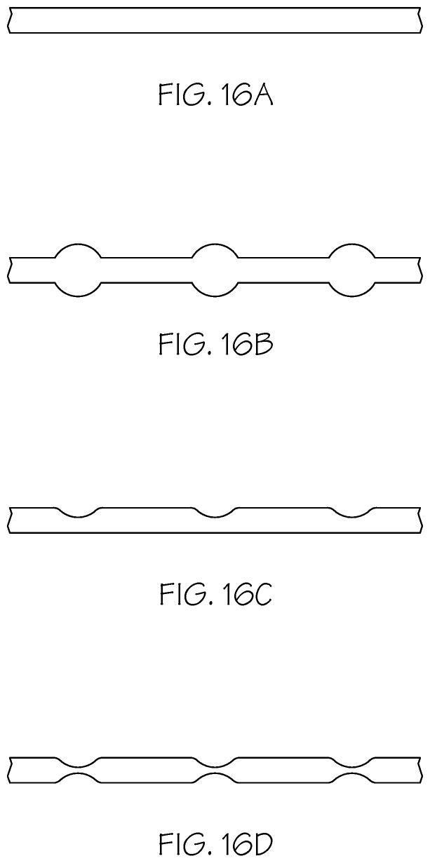

FIG. 16 shows an alternate embodiment of the structural encoding where a round wire is modified at points along its length by crushing using a tool, making the metal ‘pancake’ out, changing the apparent width of the wire at intervals. Alternatively, the wire can be squeezed in a tool, locally reducing the wire diameter The wire width at a particular point can be determined using methods similar to those in FIG. 9 to recover the data.

### II. Applications

The RFID devices described herein can be used on a variety of items or products for a variety of applications. For example, the RFID device can be in the form of a wire or tape that is integrated into a fabric structure of garment for encoding additional data. The data can be complementary to the data stored into the RFID tag, for example a data element forming parts of an anti-counterfeit cryptographic scheme, or as a form of backup of part or all of the data in the event the RFID tag ceases to function. The change in functionality can be either deliberate as part of an action to protect consumer privacy or prevent triggering of a RFID based EAS system, or after the tag stops working after an extended period on a garment or other item, to assist with recycling or other operations.

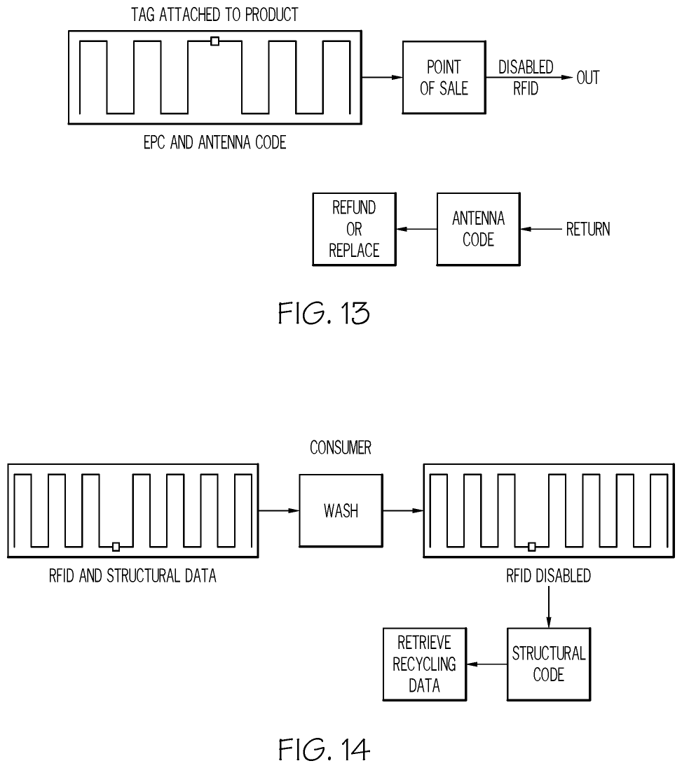

FIG. 13 illustrates how a structurally encoded tag can be used in returns management. As shown the RFID function is disabled at the point of sale to protect consumer privacy; however, when the item is returned, the structural code can be read even when embedded into a garment (where a bar code or other printed symbology would not work), and used to encode a new RFID tag in the form of a label or ticket that is attached to returned item.

FIG. 14 shows how the structurally encoded tag information can be used to assist in recycling a garment or other product at the end of life, where the RFID tag is highly likely to have failed due to washing and flexing. The structural code is used to retrieve recycling information, like a 3D map of what materials are where, so disassembly into useable sections can be carried out automatically.

It will be understood that the embodiments described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof, including as combinations of features that are individually disclosed or claimed herein.

1. An RFID device comprising:
an antenna; and
an RFID chip coupled to the antenna, wherein a data-carrying pattern that is visible at one or more wavelengths is incorporated into and/or onto the antenna.

2. The RFID device of claim 1, wherein the pattern comprises a plurality of apertures defined in the antenna.

3. The RFID device of claim 1, wherein the pattern comprises a material applied onto the antenna and having a property or properties different from the property or properties of material used to form the antenna at said one or more wavelengths.

4. The RFID device of claim 1, wherein the antenna is directly connected to the RFID chip.

5. The RFID device of claim 1, wherein the antenna is not directly connected to the RFID chip.

6. The RFID device of claim 4, wherein the RFID chip defines a portion of the pattern.

7. The RFID device of claim 6, further comprising a millimeter wave antenna associated with the RFID chip.

8. The RFID device of claim 6, wherein the pattern carries data that is optically readable at a first wavelength and data that is quasi-optically readable at a second wavelength.

9. The RFID device of claim 6, wherein the RFID device is configured to provide a modulated reflection at both ultra high and millimeter wave frequencies.

10. The RFID device of claim 6, wherein the pattern comprises at least one sensing material configured to cause the pattern to present data having a first state when a condition is existent and to present data having a second state when said condition is not existent.

11. The RFID device of claim 1, further comprising a face material that is opaque at least one wavelength and overlays at least a portion of the pattern.

12. The RFID device of claim 1, wherein the antenna comprises a plurality of layers each having a pattern or a portion of said pattern configured to be visible at a different wavelength.

13. The RFID device of claim 1, further comprising a dense material configured to cause the pattern to be visible at an X-ray wavelength.

14. The RFID device of claim 1, further comprising
a conductive backplane, and
a dielectric material, wherein the antenna and the conductive backplane are associated to opposing surfaces of the dielectric material.

15. A method of manufacturing the RFID device of claim 1, the method comprising:
providing a conductor;
defining a data-carrying pattern that is visible at one or more wavelengths into and/or onto the conductor; and
coupling the conductor to an RFID chip as an antenna.

16. The method of claim 15, wherein
the conductor is comprised of a foil material, and
the pattern is defined into and/or onto the conductor using an approach selected from the group consisting of punching, selective etching, die cutting, and laser cutting.

17. The method of claim 15, wherein
the conductor is comprised of a conductive ink, and
the pattern is defined into and/or onto the conductor by selectively printing the conductor so as to define a plurality of apertures.

18. The method of claim 15, wherein the conductor comprises an organic conducting material and the pattern is defined into and/or onto the conductor by one or more techniques selected from the group consisting of selectively printing, punching, selective etching, die cutting, laser cutting, and combinations thereof.

19. The method of claim 15, wherein
the conductor is comprised of a conductive ink, and
the pattern is defined into and/or onto the conductor by additively printing a material having a property or properties different from a property or properties of the conductive ink at said one or more wavelengths onto the conductive ink.

20. The method of claim 15, wherein coupling the conductor to the RFID chip comprises directly connecting the conductor to the RFID chip.

21. The method of claim 15, wherein coupling the conductor to the RFID chip includes not directly connecting the conductor to the RFID chip.
